(19) United States
(12) Patent Application Publication
(10) Pub. No.: US 2009/0038580 A1
(43) Pub. Date: Feb. 12, 2009

(54) OIL COOLER FOR MOTOR VEHICLES

(75) Inventor: Ian Hamilton, Scappoose, OR (US)

Correspondence Address: GANZ LAW, P.C., P O BOX 2200, HILLSBORO, OR, 97123, US

(73) Assignee: IRP,LLC, Scappoose, OR (US)

(21) Appl. No.: 12/186,124

(22) Filed: Aug. 5, 2008

Related U.S. Application Data
(60) Provisional application No. 60/954,270, filed on Aug. 6, 2007.

(51) Int. Cl. F01M 5/00; F01P 11/08; B23P 15/26

(52) U.S. Cl. 123/196 AB; 165/182; 123/196 A; 184/104.3; 29/890.035

(57) ABSTRACT

An oil cooler for an internal combustion engine, including a housing having at least one channel for receiving oil from an engine's oil reservoir and for returning the oil to the reservoir, and means for facilitating heat dissipation from the circulated oil to the environment. The oil cooler further includes a coupling for connecting the housing to a receiver for an oil filter cover so that the coupling replaces the oil filter cover and exchanges oil with the engine's reservoir.

### RELATED APPLICATIONS

This application claims the benefit of and priority to U.S. Provisional Application Ser. No. 60/954,270, filed Aug. 6, 2007, the contents of which is hereby incorporated by reference as if recited in full herein for all purposes.

### BACKGROUND

The inventive subjective matter in general relates to an oil cooler for internal combustion engines. In particular, an oil cooler for motor vehicles such as motorcycles, all terrain vehicles, watercraft, mopeds, outboard motors (for boats), snowmobile, personal watercraft, scooters, go-carts, etc.

The internal combustion engine is an engine in which the combustion of fuel and an oxidizer occurs in a confined space called a combustion chamber. This exothermic reaction creates gases at high temperature and pressure, which expand. The defining feature of an internal combustion engine is that useful work is performed by the expanding hot gases acting directly to cause movement of solid parts of the engine, by acting on pistons, rotors, or even by pressing on and moving the entire engine itself.

Internal combustion engines use motor oil as a lubricant. In engines there are parts which move very closely against each other at high speeds, often for prolonged periods of time. Such motion causes friction, absorbing otherwise useful power produced by the motor and converting the energy to useless heat. Friction also wears away the contacting surfaces of those parts, which could lead to lower efficiency and degradation of the motor. This increases fuel consumption.

Lubricating oil creates a film between surfaces of parts moving next to each other so as to minimize direct contact between them and thereby decreasing friction, wear, and production of excessive heat, thus protecting the engine. Motor oil also carries away heat from moving parts, which is important because materials tend to become softer and less abrasion-resistant at high temperatures. Coating metal parts with oil also keeps them from being exposed to oxygen, which inhibits their oxidation at elevated operating temperatures.

The two-stroke cycle of an internal combustion engine differs from the more common four-stroke cycle by completing the same four processes (intake, compression, power, exhaust) in only two strokes of the piston rather than four. This is accomplished by using the beginning of the compression stroke and the end of the power stroke to perform the intake and exhaust functions, allowing a power stroke for every revolution of the crank, instead of every second revolution as in a four-stroke engine. Two-stroke engines often have a simple lubrication system in which a special two-stroke oil is mixed with the fuel, and therefore reaches all moving parts of the engine. A four-stroke engine, however, has a lubricating system that basically consists of an oil pan, which is a reservoir or storage area for engine oil, and an oil pump, which forces oil throughout the oil passages of the engine. An oil filter strains out impurities from the oil. Additional parts, such as an oil gauge, oil pickup, oil strainers, and oil pressure indicators may be present. Rubbing of metal engine parts inevitably produces some microscopic metallic particles from the wearing of the surfaces. Sludge also accumulates in the engine. Such particles could circulate in the oil and grind against the moving parts, causing erosion and wear.

FIGS. 1-3 illustrate the position of an oil filter and prior art oil filter cover, as it relates to the crankcase of an existing motorcycle. FIG. 3 shows a part assembly of the left crankcase cover of a 2002 Honda CRF450R. HONDA™ is a trademark of Honda Motor Co., Ltd of Tokyo, Japan.

An oil filter cover 1 is typically bolted on a crankcase cover 3 that holds an oil filter 5. Crankcase 3 has a receiver 4 adapted to hold oil filter 5. Oil filter cover 1 is provided with holes 8 which correspond to tapped holes 10 in the crankcase cover 3. Bolts 6 match the holes 8 and 10 and secure the oil filter cover 1 to the crankcase cover 3. FIG. 2 shows a cylindrical oil filter of HIFLOFILTRO™, a trademark of Bike Alert Inc. of Atlanta, Ga. FIG. 3 shows how the receiver 4 may be formed by a cylindrical opening 7 in the crankcase cover 3. Oil filter 5 and its cover 1 are sealed by an O-ring 9. The oil filter 5 is further kept in place by an oil filter spring 11.

In a typical motorcycle lubrication system, an oil pump takes oil from the oil pan at the bottom of the crankcase and sends it under pressure through the oil filter into oil passageways, from which the oil lubricates the bearings holding the crankshaft and the camshaft bearings operating the valves. The oil then trickles back down into the oil pan, where it is collected, and the cycle repeats. Thus, the oil passes through the oil filter 5 under pressure. The oil is pumped into a receiver on the outside of the oil filter. The oil then passes through the filter medium to the center of the filter where it exits the receiver and proceeds to passageways in the oil filter cover.

As engines generate mechanical power, they also generate waste heat energy because they are not perfectly efficient. The engine must therefore be cooled to prevent it from overheating. In most conventional internal combustion engines some waste heat goes out with exhaust gases. However, further cooling is needed to prevent components from getting so hot that materials or lubricants will fail. The traditional engine cooling systems do not provide adequate cooling of the lubrication oil.

Accordingly, there is a need for improved oil cooling for an internal combustion engine that allows for additional cooling and convenient attachment to existing systems.

### SUMMARY

The inventive subject matter overcomes problems in the prior art by providing an oil cooler for motor vehicles with the following qualities, alone or in combination.

In its most general respect, the inventive subject matter provides an oil cooler for an internal combustion engine, including a housing having at least one channel for receiving oil from an engine's oil reservoir and for returning the oil to the reservoir, and means for facilitating heat dissipation from the circulated oil to the environment, and a coupling for connecting the housing to a receiver for an oil filter cover so that the coupling replaces the oil filter cover and exchanges oil with the engine's reservoir. In the foregoing embodiment, the coupling may further include a connector adapted to couple the housing to an oil filter of the engine. In the foregoing embodiment, the coupling may be adapted to fit conventional receivers for oil filters for a predetermined base of existing vehicles. In the foregoing embodiment, the oil cooler may be adapted to operate with the existing pressure provided by the oil pump of the engine's lubrication system. In the foregoing embodiment, the housing may include multiple, fluidly interconnected channels. In the foregoing embodiment, the means for facilitating heat dissipation may have cooling fins, which optionally may be an integral part of the housing. In the foregoing embodiment, the shape of the cooling fins may be adapted to accommodate placement of the oil cooler on the engine. In the foregoing embodiment, the coupling may be directly boltable on the crankcase of the engine.

In another possible embodiment, an oil cooler for an internal combustion engine, may include a housing having an interior provided with a continuous channel for receiving oil from an engine's oil reservoir and for returning the oil to the reservoir, the channel following a course that enhances heat dissipation from the oil to the housing, and the housing having an exterior provided with means to facilitate heat dissipation from the housing to the environment. The housing may further include a coupling for connecting the housing to a receiver for an oil filter cover so that the coupling replaces the oil filter cover and the coupling adapted to receive hot oil from the engine's reservoir, to fluidly couple to the channel in the housing, and to return substantially cooler oil from the housing to the engine's reservoir. In the foregoing embodiment, the channel may proceed by multiple turns in alternating directions.

In another possible embodiment, an oil cooler for a four-stroke engine of a motorcycle, may include a housing having an interior provided with a continuous channel for receiving hot oil from the engine's oil reservoir, for circulating the oil, and for returning the oil to the reservoir, and the housing having an exterior provided with a plurality of cooling fins for facilitating heat dissipation from the circulated oil in the channel to the environment; and a coupling for connecting the housing to a receiver for an oil filter cover on the crankcase of the engine so that the coupling replaces the oil filter cover and the coupling receiving pressurized hot oil from the engine's oil filter, leading the oil to the housing channel, and returning substantially cooler oil from the housing to the engine's oil passageway; and having a connector adapted to couple the housing to an oil filter of the engine. In the foregoing embodiment, the oil cooler may be boltable to the crankcase of a motorcycle and the coupling may be adapted to fit conventional receivers for oil filters for a predetermined base of existing vehicles. In the foregoing embodiment, the dimensions of the channel may be adapted to work with the existing pressure of the oil pump of the engine's lubrication system.

The inventive subject matter further contemplates a method for making an oil cooler, including the steps of providing a housing with at least one channel for receiving hot oil from an engine's reservoir, for circulating the oil within the housing, and for returning the oil to the reservoir; providing the housing with means for facilitating heat dissipation from the circulated oil to the environment; providing the oil cooler with a coupling for fluidly connecting the housing to a receiver for an oil filter. In the foregoing method, the housing may be made of two or more complementary housing elements forming an interior channel by complementary grooves in each housing element and the housing elements fitting together so that the oil is contained within the interior channel. The housing may be provided with a seal adapted to contain oil within the complementary grooves of the housing elements. In the foregoing method, the means for facilitating heat dissipation may include multiple cooling fins located on the exterior of the housing. In the foregoing method, the oil cooler may comprise aluminum.

The inventive subject matter further contemplates a method for using an oil cooler on a motorcycle, including the steps of removing an existing oil filter cover from the crankcase cover of the motorcycle. Further providing an oil cooler having a housing with an interior provided with a continuous channel for receiving hot oil from the engine's oil reservoir, for circulating the oil, and for returning the oil to the reservoir, and the housing having an exterior provided with a plurality of cooling fins for facilitating heat dissipation from the circulated oil in the channel to the environment; and having a coupling for fluidly connecting the housing to a receiver for an oil filter cover on the crankcase of the engine so that the coupling replaces the oil filter cover and the coupling receiving pressurized hot oil from the engine's oil filter, leading the oil to the housing channel, and returning substantially cooler oil from the housing to the engine's oil passageway, and having a connector adapted to couple the housing to an oil filter of the engine, and the coupling comprising a connector adapted to couple the housing to an oil filter of the engine. Subsequently the method includes, aligning the connector of the oil cooler with the oil filter and aligning the oil passageways of the oil cooler with the engine's oil passageways. The method further includes, securing the coupling of the oil cooler to the crankcase cover of the motorcycle to allow pressurized hot oil to enter the oil cooler and to return substantially cooler oil to the motorcycle's engine.

These and other embodiments are described in more detail in the following detailed descriptions and the figures.

The foregoing is not intended to be an exhaustive list of embodiments and features of the inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter, unless noted as showing prior art.

FIG. 1 is a perspective view of a motorcycle engine showing on oil filter cover according to the prior art.

FIG. 2 is a perspective view of a disassembled oil filter cover and oil filter of a motorcycle according to the prior art.

FIG. 3 is a perspective view of a parts assembly of a left crankcase cover according to the prior art.

FIG. 4 is a perspective view of a motorcycle engine showing an oil cooler according to the inventive subject matter disclosed herein as it is coupled to the crankcase of an engine.

FIG. 5 is a perspective view of an oil cooler, shown as it is coupled to an oil filter of a motorcycle.

FIG. 6A is a perspective view of the interior of an outer housing element and connector of the oil cooler shown in FIG. 5.

FIG. 6B is a perspective view of the exterior of an inner housing element and connector of the oil cooler shown in FIG. 5.

FIG. 7A is a front view of the interior of an inner housing element and connector of the oil cooler shown in FIG. 5.

FIG. 7B is a front view of the exterior of an outer housing element and connector of the oil cooler shown in FIG. 5.

FIGS. 8 and 9 show additional features and views of the inventive subject matter disclosed herein.

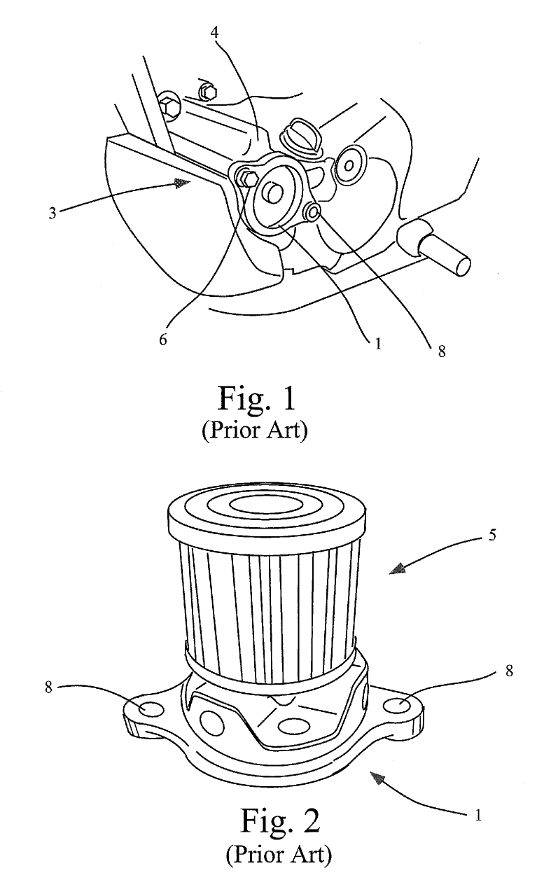

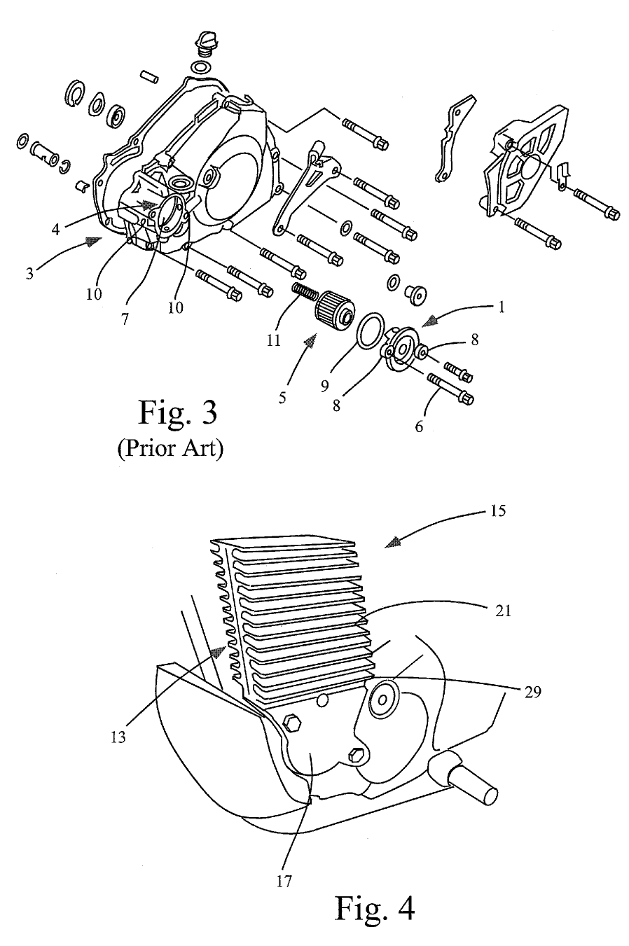

### DETAILED DESCRIPTION

Representative embodiments according to the inventive subject matter are shown in FIGS. 4-9, wherein the same or generally similar features share common reference numerals.

The inventive subject matter relates in general to an oil cooler for an internal combustion engine, such as for a motor vehicle, adapted to provide cooling of the engine's lubrication oil by incorporating an oil cooler or radiator into the existing lubrication system of the engine. In particular, the oil cooler may be used for motor vehicles such as motorcycles, all terrain vehicles, watercraft, mopeds, outboard motors (for boats), snowmobile, personal watercraft, scooters, go-carts, etc.

The oil cooler is adapted to fit conventional receivers for oil filter covers in such a manner that the oil cooler may be used as a retro-fit for a large base of existing and new vehicles without expansive re-engineering of the engine and its lubrication system. The oil cooler may be a one-piece design that is easily integrated into an existing lubrication system. The additional cooling provided by the oil cooler will increase the engine's life for the motor vehicle users. The additional cooling will also expand the oil's performance capabilities and useful lifetime.

The oil cooler includes a housing having at least one channel for receiving oil from an engine's oil reservoir and returning the oil to the reservoir. The housing also includes means for facilitating heat dissipation from the circulated oil to the environment. The oil cooler farther includes a coupling for connecting the oil cooler to a receiver on the engine for an oil filter cover so that the coupling replaces the oil filter cover and exchanges oil with the engine's reservoir.

In general, in a four-stroke engine the oil lubricates rotating or sliding surfaces in the crankcase, such as between the pistons, cylinder, crankshaft components, rods and bearings. The oil is pressure-fed from the oil passageways to the main bearings and enters holes in the main journals of the crankshaft. The oil proceeds through passageways inside the crankshaft to lubricate the rod bearings and connecting rods. The oil also lubricates the contacting surfaces between the piston rings and interior surfaces of the cylinders. An oil film serves as a seal between the piston rings and cylinder walls to separate the combustion chamber in the cylinder head from the crankcase. During this entire lubrication process the oil will take up heat from its environment.

The following representative embodiments illustrate an oil cooler as it is used with a four-stroke motorcycle engine. FIGS. 4-9 illustrate how one embodiment of the inventive subject matter may be used to provide additional cooling to motor oil of a HONDA™ motorcycle. An oil cooler may be coupled to the HIFLOFILTRO™ oil filter described above. The oil is cooled by the oil cooler and this cycle is repeated, to continually remove heat from the oil.

The oil cooler may include a housing and a coupling for connecting the oil cooler to a receiver on the engine so that the connector replaces the oil filter cover and exchanges oil with the engine.

The interior of the housing may include a continuous channel for receiving hot oil from the engine's oil reservoir and returning substantially cooler oil to the reservoir. The channel may have various shapes or forms that enhance heat dissipation from the oil to the environment, such as a single continuous path or multiple fluidly interconnected paths proceeding in and out the housing, or a chamber within the housing.

The exterior of the housing includes means for facilitating heat dissipation from the housing to the environment, such as an increase of the conductive surface area, or channels surrounded by cooling liquid, such as adjacent water cooling; forced air, such as a fan; etc.

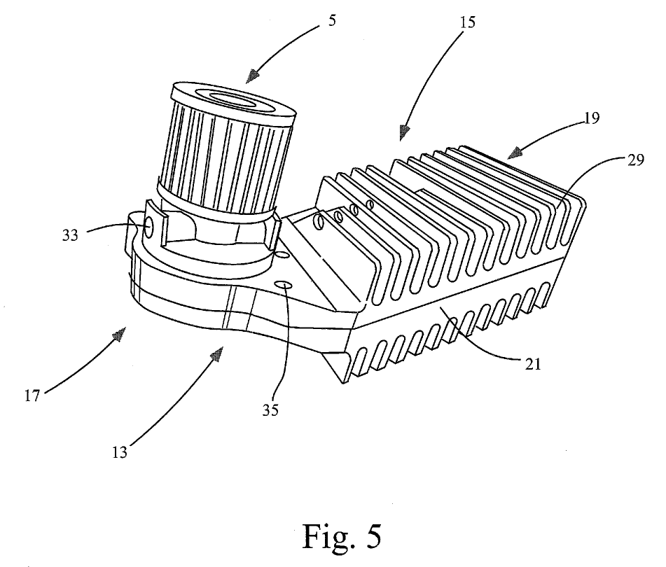

In the example shown, the oil cooler 13 has a housing 15 with at least one cooling channel and a coupling 17 for connecting the cooler to an engine. FIG. 4 shows how the oil cooler 13 is mounted in a substantially upright position on the crankcase of a motorcycle, thereby replacing the existing oil filter cover. FIGS. 5-8 illustrate one possible embodiment of a disassembled housing 15 having two complementary housing elements, inner housing element 19, which faces the engine, and outer housing element 21, which faces away from the engine. Although shown as two elements, the housing may be made up of any number of elements. The interior of housing 15 is provided with a continuous channel 25 adapted to contain oil. The channels may be formed, for example, by complementary grooves 27 in housing elements 19 and 21. To enhance heat dissipation from the oil to the housing, the channels follow a path of multiple turns in alternating directions, in this case, a zigzag path 31 through housing 15. The complementary housing elements are fitted together so that the oil is contained within the channels and within the housing. Housing elements 19 and 21 may be bolted together and sealed by a seal or gasket clamped between the two housing elements. However, the housing elements may be connected by any other suitable means.

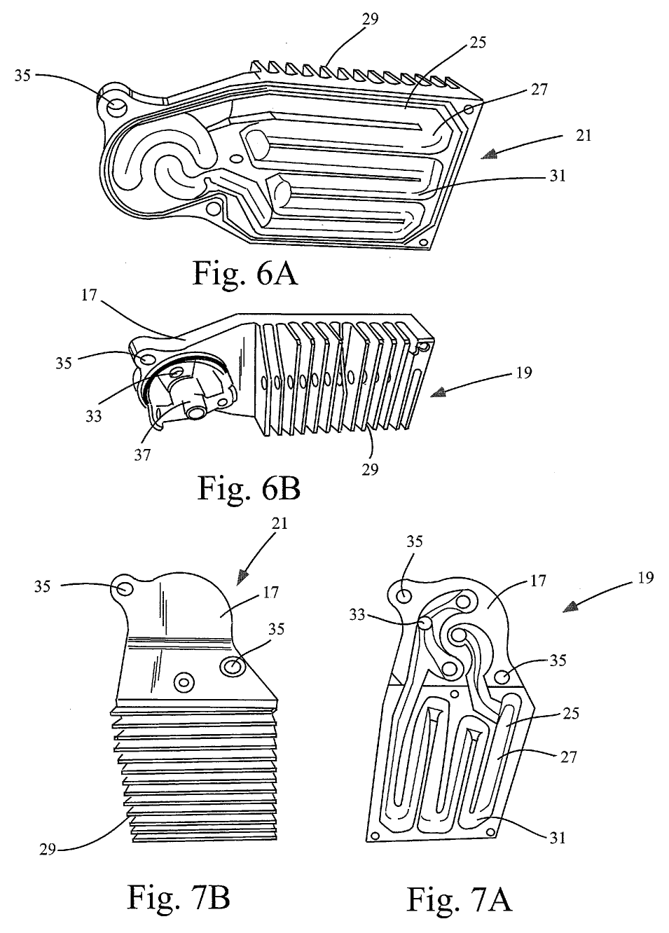

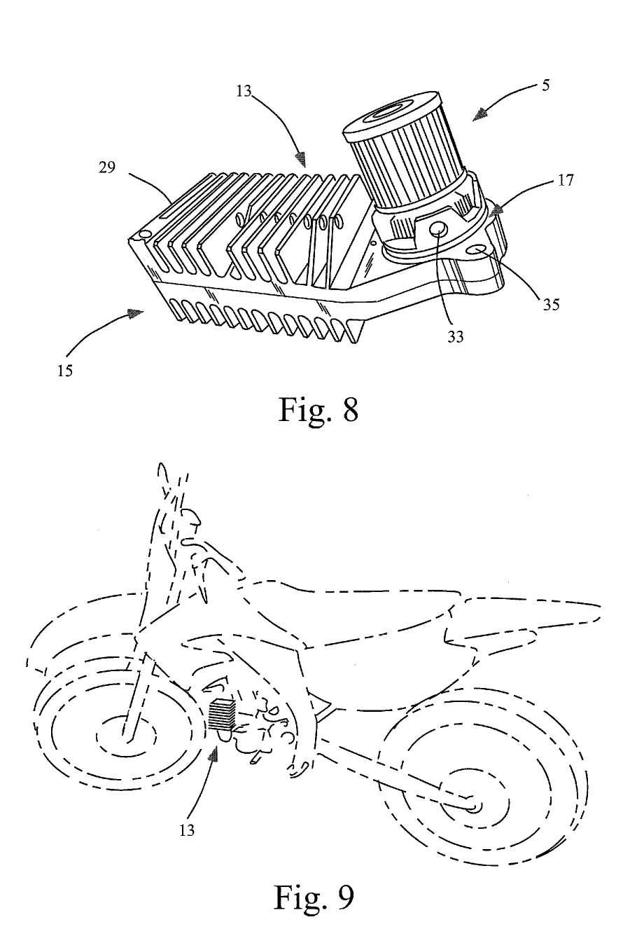

The exterior of the housing 15 includes parallel extending cooling fins 29 to dissipate heat from the housing to the environment. In this example, both housing elements are provided with multiple cooling fins, and form an integral part of the housing. As can be seen on FIGS. 6B and 8, the shape of the fins 29 may be adapted to fit the shape of the engine they face. However, it is understood, that heat dissipation may also be accomplished with only one housing element having cooling means. Alternatively, cooling fins may also form a distinct part of the housing, for example, by being made from a material that is different from the housing and that has desirable conductive capabilities. The addition of fins adds to the total volume of material making a heat sink and thus provides for greater efficiency in cooling. The dimensions of the housing 15 shown in the figures are approximately 15 cm in length, 8 cm in width, and 4 cm depth. Channel 25 within housing 15 has a diameter of approximately 0.9 cm, following a zigzag path 31 with five sharp turns over the width of housing 15. These are exemplary dimensions only and may be adjusted by one skilled in the art. It is believed that this embodiment may reduce the oil temperature by up to 40 degrees Fahrenheit, depending on the environment.

FIGS. 4-8 show a coupling 17 adapted to couple housing 15 to a receiver 4 for an oil filter 5, such that it replaces an existing oil filter cover 1. Coupling 17 is adapted to receive hot oil from oil filter 5 and return cooled oil to the different lubrication points such as oil passageways, for example, passageways 33 which lead to the crankcase. As illustrated in the figures, coupling 17 may be formed by two complementary parts having complementary grooves that form a channel in communication with the housing channel and the engine's oil reservoir. An O-ring may seal the connection between the coupling and the crankcase cover. The existing oil pump of the lubrication system provides sufficient pressure to the oil to proceed through the oil cooler, and the oil cooler is designed to accommodate the existing pressure.

FIG. 6B also shows a connector 37 which couples the housing to an oil filter. FIG. 6B shows connector 37 as a hollow cylindrical part for connecting coupling 17 of an oil cooler to the oil outlet of an oil filter. In particular, connector 37 is adapted to complement the outlet of an existing oil filter, such as the above-mentioned HIFLOFILTRO™ filter. After the existing oil cover has been removed, connector 37 is coupled to the oil outlet in the center of the existing oil filter. The housing is positioned so that cooled oil can flow through passageways 33 to the crankcase of the engine. Subsequently, the coupling of the housing to the crankcase may be sealed and the oil cooler is bolted to the crankcase cover.

The oil cooler may be configured to directly bolt to the crankcase, requiring no further modifications of the motorcycle. For example, the bolts 6 fit in holes 35 in the oil cooler and corresponding existing tapped holes 10 in the crankcase of the motorcycle. As shown, both housing elements 19 and 21 are provided with complementary holes 35 to match bolts that fit holes 10 in the crankcase cover 3. However, attachment to the crankcase may occur at any suitable location and with any suitable means.

The inventive subject matter herein also includes a method for making an oil cooler. The oil cooler illustrated in the figures is formed from 6061-T6 billet aluminum to optimize heat exchange, maintain strength, while being light-weight. However, it is understood that any other suitable material may be used. The embodiment shown may be manufactured by, for example, Computer Numerical Control (CNC) milling, but many other methods may be used to manufacture such an oil cooler, for example die casting.

The inventive subject matter herein further includes a method for using an oil cooler on an existing combustion engine.

Persons skilled in the art will recognize that many modifications and variations are possible in the details, materials, and arrangements of the parts and actions which have been described and illustrated in order to explain the nature of this inventive subject matter, and that such modifications and variations do not depart from the spirit and scope of the teachings and claims contained therein.

All patent and non-patent literature cited herein is hereby incorporated by references in its entirety for all purposes.

Currently claimed inventions:

1. An oil cooler for an internal combustion engine, comprising:
a housing having at least one channel for receiving oil from an engine's oil reservoir and for returning the oil to the reservoir, and means for facilitating heat dissipation from the circulated oil to the environment, and
a coupling for connecting the housing to a receiver for an oil filter cover so that the coupling replaces the oil filter cover and exchanges oil with the engine's reservoir.

2. The oil cooler of claim 1, wherein the coupling further comprises a connector adapted to couple the housing to an oil filter of the engine.

3. The oil cooler of claim 1, wherein the coupling is adapted to fit conventional receivers for oil filters for a predetermined base of existing vehicles.

4. The oil cooler of claim 1, wherein the oil cooler is adapted to operate with the existing pressure provided by the oil pump of the engine's lubrication system.

5. The oil cooler of claim 1, wherein the housing comprises multiple, fluidly interconnected channels.

6. The oil cooler of claim 1, wherein the means for facilitating heat dissipation comprise cooling fins.

7. The oil cooler of claim 6, wherein the cooling fins are an integral part of the housing.

8. The oil cooler of claim 6, wherein the shape of the cooling fins is adapted to accommodate placement of the oil cooler on the engine.

9. The oil cooler of claim 1, wherein the coupling is directly boltable on the crankcase of the engine.

10. An oil cooler for an internal combustion engine, comprising:
a housing having an interior provided with a continuous channel for receiving oil from an engine's oil reservoir and for returning the oil to the reservoir, the channel following a course that enhances heat dissipation from the oil to the housing, and the housing having an exterior provided with means to facilitate heat dissipation from the housing to the environment; and
a coupling for connecting the housing to a receiver for an oil filter cover so that the coupling replaces the oil filter cover, and the coupling adapted to receive hot oil from the engine's reservoir, to fluidly couple to the channel in the housing, and to return substantially cooler oil from the housing to the engine's reservoir.

11. The oil cooler of claim 10, wherein the channel proceeds by multiple turns in alternating directions.

12. An oil cooler for a four-stroke engine of a motorcycle, comprising:
a housing having an interior provided with a continuous channel for receiving hot oil from the engine's oil reservoir, for circulating the oil, and for returning the oil to the reservoir, and the housing having an exterior provided with a plurality of cooling fins for facilitating heat dissipation from the circulated oil in the channel to the environment; and
a coupling for connecting the housing to a receiver for an oil filter cover on the crankcase of the engine so that the coupling replaces the oil filter cover and the coupling receiving pressurized hot oil from the engine's oil filter, leading the oil to the housing channel, and returning substantially cooler oil from the housing to the engine's oil passageway, and having a connector adapted to couple the housing to an oil filter of the engine.

13. The oil cooler of claim 12, wherein the oil cooler is boltable to the crankcase of the motorcycle and wherein the coupling is adapted to fit conventional receivers for oil filters for a predetermined base of existing vehicles.

14. The oil cooler of claim 12, wherein the dimensions of the channel are adapted to work with the existing pressure of the oil pump of the engine's lubrication system.

15. A method for making an oil cooler, comprising the steps of:
providing a housing with at least one channel for receiving hot oil from an engine's reservoir, for circulating the oil within the housing, and for returning the oil to the reservoir;
providing the housing with means for facilitating heat dissipation from the circulated oil to the environment;
providing the oil cooler with a coupling for fluidly connecting the housing to a receiver for an oil filter.

16. The method of claim 15, wherein the housing is made of two or more complementary housing elements forming an interior channel by complementary grooves in each housing element and the housing elements fitting together so that the oil is contained within the interior channel.

17. The method of claim 16, wherein the housing is further provided with a seal adapted to contain oil within the complementary grooves of the housing elements.

18. The method of claim 15, wherein the means for facilitating heat dissipation include multiple cooling fins located on the exterior of the housing.

19. The method of claim 15, wherein the oil cooler comprises aluminum.

20. A method for using an oil cooler on a motorcycle, comprising the steps of:
removing an existing oil filter cover from the crankcase cover of the motorcycle;
providing an oil cooler having a housing with an interior provided with a continuous channel for receiving hot oil from the engine's oil reservoir, for circulating the oil, and for returning the oil to the reservoir, and the housing having an exterior provided with a plurality of cooling fins for facilitating heat dissipation from the circulated oil in the channel to the environment; and having a coupling for fluidly connecting the housing to a receiver for an oil filter cover on the crankcase of the engine so that the coupling replaces the oil filter cover and the coupling receiving pressurized hot oil from the engine's oil filter, leading the oil to the housing channel, and returning substantially cooler oil from the housing to the engine's oil passageway, and having a connector adapted to couple the housing to an oil filter of the engine, and the coupling comprising a connector adapted to couple the housing to an oil filter of the engine; and
aligning the connector of the oil cooler with the oil filter;
aligning the oil passageways of the oil cooler with the engine's oil passageways; and
securing the coupling of the oil cooler to the crankcase cover of the motorcycle to allow pressurized hot oil to enter the oil cooler and to return substantially cooler oil to the motorcycle's engine.
